(19) United States
(12) Patent Application Publication
(10) Pub. No.: US 2007/0221768 A1
(43) Pub. Date: Sep. 27, 2007

(54) Shredder having an illuminator

(75) Inventor: Tie Chun Wang, SanChung City (TW)

Correspondence Address: BACON & THOMAS, PLLC, 625 SLATERS LANE, FOURTH FLOOR, ALEXANDRIA, VA, 22314, US

(73) Assignee: Michilin Prosperity Co., Ltd., SanChung City (TW)

(21) Appl. No.: 11/727,535

(22) Filed: Mar. 27, 2007

(30) Foreign Application Priority Data
Mar. 27, 2006 (TW) 095205060

(51) Int. Cl. B02C 18/16

(52) U.S. Cl. 241/101.3

(57) ABSTRACT

Disclosed is a shredder, where the shredder is provided with an illuminator neighboring a bottom paper shredder thereof. The illuminator is electrically connected to an activating circuit of the shredder motor, such that the illuminator is illuminated at the same time of activating a motor for driving the paper shredding cutter, and turned off at the same of deactivating the motor after completing the shredding, so as to feature the shredding operation with playful interest.

### CROSS-REFERENCES TO RELATED APPLICATIONS

Not Applicable

### STATEMENT REGARDING FEDERALLY SPONSORED RESEARCH OR DEVELOPMENT

Not Applicable

### DESCRIPTION

1. Field of Invention

This invention relates to a shredder, particular to one having an illuminator so as to feature the shredding operation with playful interest.

2. Background

The conventional shredders for cutting paper use a plurality of cutting blades and spacers engaging over a rotary shaft, and the shearing force that two parallel and opposite rotary shafts produce by a motor and a gear box for transferring and cutting the paper-to-be-cut along a longitudinal direction into strips. Shredders can be classed into two types, the stripe-cut shredders and crosscut shredders, according to the machine cutting style. The former shredders arrange cutting blades to the rotating shafts in a manner to cutting the paper in a longitudinal direction to form strips. The later shredders include blades that include more than one cutting edge part, and each cutter is disposed helically along the rotary shaft for first cutting paper along a horizontal direction into strips and then cutting paper along a longitudinal direction into approximate 4 mm×40 mm paper chips. Regardless of being stripe-cut shredders and crosscut shredders, a basket or bin for containing paper chips usually accompanies the shredder at sales.

The maximum sheet capacity of the conventional paper shredders is dependent on the motor load and the limitations of the cutting blades and rotary shafts. Thus, when a large amount of paper is to be destroyed, the user must continuously feed the paper that is within the maximum sheet capacity of the paper shredded into the paper shredder manually in order to destroy the entire batch of documents. Experiences show that, continuous and repetitive shredding operations are simple and dull. Therefore, the industry has attempted to feature the shredding operation with playful interest so as to win consumers' favors.

### SUMMARY OF INVENTION

It is a primary object of this invention to provide a shredder having an illuminator, where the illuminator is illuminated at the same time of activating a motor for driving the paper shredding cutter, and turned off at the same of deactivating the motor after completing the shredding, so as to feature the shredding operation with playful interest.

To achieve the above object, this invention provides a shredder, where the shredder is provided with an illuminator neighboring a bottom paper shredder thereof. The illuminator is electrically connected to an activating circuit of the shredder motor, such that the illuminator is illuminated at the same time of activating a motor for driving the paper shredding cutter, and turned off at the same of deactivating the motor after completing the shredding, so as to feature the shredding operation with playful interest.

### BRIEF DESCRIPTION OF THE DRAWINGS

These and other modifications and advantages will become even more apparent from the following detailed description of a preferred embodiment of the invention and from the drawings in which:

FIG. 1 is a bottom perspective view showing the shredder of this invention; and

FIG. 2 is a schematic view illustrating an embodiment of this invention.

### DETAILED DESCRIPTION OF THE INVENTION (PREFERRED EMBODIMENTS)

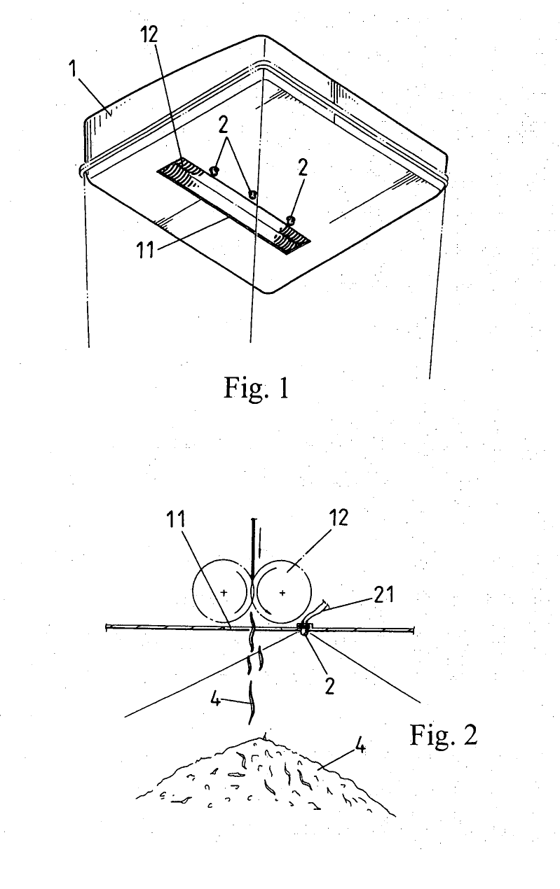

With reference to the drawings, FIGS. 1 and 2 illustrate a bottom perspective view showing the shredder of this invention, and a schematic view illustrating an embodiment of this invention, respectively.

As shown, the shredder 1 is provided with at least one illuminator 2 neighboring a bottom paper outlet 11 thereof. The illuminator 2 may be a light emitting diode or any other kind of lighting source, and the illuminator 2 is electrically connected to a motor activating circuit (not shown) of the shredder 1, such that the illuminator 2 is illuminated at the same time of activating a motor for driving the paper shredding cutter 12, and turned off at the same of deactivating the motor after completing the shredding. Thus, during shredding operation, non-precedent visual effects can thus been rendered by the shredded paper chips 4 falling from the paper outlet 11 into a basket or bin 3, and illuminated by the illuminator 2, so as to feature the shredding operation with playful interest, and to allow the operator to clearly observe that the documents to be destroyed have been completed shredded into chips.

Furthermore, while implementing plural illuminators 2, a colorful RGB module (RGB) or a running information LED display mode may be adopted to enhance lighting variations, so as to stimulate visual sense and to enhance playful interest provided by the shredding operation.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A shredder having an illuminator, including: at least one illuminator neighboring a bottom paper shredder thereof, the illuminator being electrically connected to a motor activating circuit of the shredder, such that the illuminator is illuminated at the same time of activating a motor for driving the paper shredding cutter, and turned off at the same of deactivating the motor after completing the shredding.

2. The shredder having an illuminator according to claim 1, wherein the illuminator is a light emitting diode (LED).

3. The shredder having an illuminator according to claim 2, wherein the shredder having plural illuminators that are of a colorful RGB module or running information LED display to enhance lighting variations.

4. The shredder having an illuminator according to claim 1, wherein the illuminator is any other type of lighting source.
